(19) United States
(12) Patent Application Publication
(10) Pub. No.: US 2025/0063401 A1
(43) Pub. Date: Feb. 20, 2025

(54) TECHNIQUES FOR CONFIGURING PHASE TRACKING REFERENCE SIGNAL TRANSMISSIONS

(71) Applicant: QUALCOMM INCORPORATED, San Diego, CA (US)

(72) Inventors: Idan Michael Horn, Hod Hasharon (IL); Shay Landis, Hod Hasharon (IL); Yehonatan Dallal, Kfar Saba (IL); Gideon Shlomo Kutz, Ramat Hasharon (IL)

(21) Appl. No.: 18/720,577

(22) PCT Filed: Jan. 2, 2023
(86) PCT No.: PCT/US2023/010007

§ 371 Date: Jun. 14, 2024

(30) Foreign Application Priority Data
Feb. 4, 2022 (IL) 290354

(51) Int. Cl. H04W 24/08; H04L 5/00; H04W 8/22; H04W 76/20

(52) U.S. Cl. CPC H04W 24/08; H04L 5/0051; H04W 8/22; H04W 76/20

(57) ABSTRACT

Methods, systems, and devices for wireless communication are described. A base station may configure multiple phase tracking reference signal (PTRS) patterns in a single time interval (e.g., a slot) to improve phase tracking and phase noise estimation. The base station may transmit control signaling indicating multiple PTRS patterns for the time interval, and a user equipment (UE) may monitor for PTRSs in the time interval according to the indicated patterns to estimate a phase for receiving a downlink message from the base station. In some examples, the UE may signal a list of preferred PTRS patterns for the base station to use based on channel conditions. For example, the UE may transmit a report indicating one or more preferred PTRS patterns and a respective quantity of symbols in which the base station is to use each pattern.

### CROSS REFERENCE

The present Application is a 371 national stage filing of International PCT Application No. PCT/US2023/010007 by HORN et al. entitled “TECHNIQUES FOR CONFIGURING PHASE TRACKING REFERENCE SIGNAL TRANSMISSIONS,” filed Jan. 2, 2023; and claims priority to Israel Patent Application No. 290354 by HORN et al. entitled “TECHNIQUES FOR CONFIGURING PHASE TRACKING REFERENCE SIGNAL TRANSMISSIONS,” filed Feb. 4, 2022, each of which is assigned to the assignee hereof, and each of which is expressly incorporated by reference in its entirety herein.

### FIELD OF TECHNOLOGY

The following relates to wireless communication, including techniques for configuring phase tracking reference signal transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A UE may be configured to monitor for reference signals from a base station. However, for some use cases, existing reference signal techniques may be deficient in some current configurations.

### SUMMARY

The described techniques relate to improved methods, systems, devices, and apparatuses that support techniques for configuring phase tracking reference signal transmissions. Generally, the described techniques provide for configuring multiple phase tracking reference signal (PTRS) patterns in a single time interval (e.g., a slot) to improve phase tracking and phase noise estimation. A base station may transmit control signaling indicating multiple PTRS patterns for the time interval, and a user equipment (UE) may monitor for PTRSs in the time interval according to the indicated patterns to estimate a phase for receiving a downlink message from the base station. In some examples, the UE may signal a list of preferred PTRS patterns for the base station to use based on channel conditions. For example, the UE may transmit a report indicating one or more preferred PTRS patterns and a respective quantity of symbols in which the base station is to use each pattern.

A method for wireless communication at a UE is described. The method may include receiving control signaling indicating a set of phase tracking reference signal patterns and scheduling transmission of a downlink message during a transmission time interval, monitoring, based on receiving the control signaling, for a first one or more phase tracking reference signals according to a first pattern of the set of phase tracking reference signal patterns in a first portion of the transmission time interval, monitoring, based on receiving the control signaling, for a second one or more phase tracking reference signals according to a second pattern of the set of phase tracking reference signal patterns in a second portion of the transmission time interval, and monitoring, in accordance with the control signaling, the transmission time interval for the downlink message based on a phase estimate determined using the first one or more phase tracking reference signals and the second one or more phase tracking reference signals.

An apparatus for wireless communication at a UE is described. The apparatus may include a processor and a memory coupled with the processor. The memory may include instructions executable by the processor to cause the apparatus to receive control signaling indicating a set of phase tracking reference signal patterns and scheduling transmission of a downlink message during a transmission time interval, monitor, based on receiving the control signaling, for a first one or more phase tracking reference signals according to a first pattern of the set of phase tracking reference signal patterns in a first portion of the transmission time interval, monitor, based on receiving the control signaling, for a second one or more phase tracking reference signals according to a second pattern of the set of phase tracking reference signal patterns in a second portion of the transmission time interval, and monitor, in accordance with the control signaling, the transmission time interval for the downlink message based on a phase estimate determined using the first one or more phase tracking reference signals and the second one or more phase tracking reference signals.

Another apparatus for wireless communication at a UE is described. The apparatus may include means for receiving control signaling indicating a set of phase tracking reference signal patterns and scheduling transmission of a downlink message during a transmission time interval, means for monitoring, based on receiving the control signaling, for a first one or more phase tracking reference signals according to a first pattern of the set of phase tracking reference signal patterns in a first portion of the transmission time interval, means for monitoring, based on receiving the control signaling, for a second one or more phase tracking reference signals according to a second pattern of the set of phase tracking reference signal patterns in a second portion of the transmission time interval, and means for monitoring, in accordance with the control signaling, the transmission time interval for the downlink message based on a phase estimate determined using the first one or more phase tracking reference signals and the second one or more phase tracking reference signals.

A non-transitory computer-readable medium storing code for wireless communication at a UE is described. The code may include instructions executable by a processor to receive control signaling indicating a set of phase tracking reference signal patterns and scheduling transmission of a downlink message during a transmission time interval, monitor, based on receiving the control signaling, for a first one or more phase tracking reference signals according to a first pattern of the set of phase tracking reference signal patterns in a first portion of the transmission time interval, monitor, based on receiving the control signaling, for a second one or more phase tracking reference signals according to a second pattern of the set of phase tracking reference signal patterns in a second portion of the transmission time interval, and monitor, in accordance with the control signaling, the transmission time interval for the downlink message based on a phase estimate determined using the first one or more phase tracking reference signals and the second one or more phase tracking reference signals.

Some examples of the method, apparatuses, and non-transitory computer-readable medium described herein may further include operations, features, means, or instructions for transmitting a signal indicating a UE capability associated with the set of phase tracking reference signal patterns, where the control signaling may be received based on the UE capability.

In some examples of the method, apparatuses, and non-transitory computer-readable medium described herein, the signal may be transmitted in a radio resource control message.

Some examples of the method, apparatuses, and non-transitory computer-readable medium described herein may further include operations, features, means, or instructions for transmitting, based on monitoring for the first one or more phase tracking reference signals and the second one or more phase tracking reference signals, a signal indicating one or more phase tracking reference signal patterns of the set of phase tracking reference signal patterns and monitoring, based on transmitting the signal, for a third one or more phase tracking reference signals according to a third pattern of the set of phase tracking reference signal patterns in a portion of a second transmission time interval.

Some examples of the method, apparatuses, and non-transitory computer-readable medium described herein may further include operations, features, means, or instructions for receiving a lookup table identifying the set of phase tracking reference signal patterns, where the signal indicates the one or more phase tracking reference signal patterns based on the lookup table.

In some examples of the method, apparatuses, and non-transitory computer-readable medium described herein, the signal further indicates a quantity of symbols associated with the indicated one or more phase tracking reference signal patterns and the portion of the second transmission time interval includes the indicated quantity of symbols.

In some examples of the method, apparatuses, and non-transitory computer-readable medium described herein, the quantity of symbols may be indicated in one or more bits in the signal.

In some examples of the method, apparatuses, and non-transitory computer-readable medium described herein, the indicated one or more phase tracking reference signal patterns include the third pattern.

In some examples of the method, apparatuses, and non-transitory computer-readable medium described herein, the indicated one or more phase tracking reference signal patterns may be based on a channel delay spread, a back off associated with a fast Fourier transform operation, an integrated phase noise, or any combination thereof.

In some examples of the method, apparatuses, and non-transitory computer-readable medium described herein, the indicated one or more phase tracking reference signal patterns may be based on a signal to interference plus noise ratio, a rank indicator, a channel quality indicator, a modulation and coding scheme, a precoding matrix indicator, or any combination thereof.

In some examples of the method, apparatuses, and non-transitory computer-readable medium described herein, the signal may be transmitted in a periodic report or an aperiodic report.

In some examples of the method, apparatuses, and non-transitory computer-readable medium described herein, the signal may be transmitted in a physical uplink channel transmission or in a channel state feedback report.

In some examples of the method, apparatuses, and non-transitory computer-readable medium described herein, the control signaling includes a radio resource control message, a medium access control control element, a downlink control information message, or any combination thereof.

A method for wireless communication at a base station is described. The method may include transmitting, to a UE, control signaling indicating a set of phase tracking reference signal patterns and scheduling transmission of a downlink message during a transmission time interval, transmitting, based on transmitting the control signaling, a first one or more phase tracking reference signals according to a first pattern of the set of phase tracking reference signal patterns in a first portion of the transmission time interval, transmitting, based on transmitting the control signaling, a second one or more phase tracking reference signals according to a second pattern of the set of phase tracking reference signal patterns in a second portion of the transmission time interval, and transmitting the downlink message in accordance with the control signaling.

An apparatus for wireless communication at a base station is described. The apparatus may include a processor and a memory coupled with the processor. The memory may include instructions executable by the processor to cause the apparatus to transmit, to a UE, control signaling indicating a set of phase tracking reference signal patterns and scheduling transmission of a downlink message during a transmission time interval, transmit, based on transmitting the control signaling, a first one or more phase tracking reference signals according to a first pattern of the set of phase tracking reference signal patterns in a first portion of the transmission time interval, transmit, based on transmitting the control signaling, a second one or more phase tracking reference signals according to a second pattern of the set of phase tracking reference signal patterns in a second portion of the transmission time interval, and transmit the downlink message in accordance with the control signaling.

Another apparatus for wireless communication at a base station is described. The apparatus may include means for transmitting, to a UE, control signaling indicating a set of phase tracking reference signal patterns and scheduling transmission of a downlink message during a transmission time interval, means for transmitting, based on transmitting the control signaling, a first one or more phase tracking reference signals according to a first pattern of the set of phase tracking reference signal patterns in a first portion of the transmission time interval, means for transmitting, based on transmitting the control signaling, a second one or more phase tracking reference signals according to a second pattern of the set of phase tracking reference signal patterns in a second portion of the transmission time interval, and means for transmitting the downlink message in accordance with the control signaling.

A non-transitory computer-readable medium storing code for wireless communication at a base station is described. The code may include instructions executable by a processor to transmit, to a UE, control signaling indicating a set of phase tracking reference signal patterns and scheduling transmission of a downlink message during a transmission time interval, transmit, based on transmitting the control signaling, a first one or more phase tracking reference signals according to a first pattern of the set of phase tracking reference signal patterns in a first portion of the transmission time interval, transmit, based on transmitting the control signaling, a second one or more phase tracking reference signals according to a second pattern of the set of phase tracking reference signal patterns in a second portion of the transmission time interval, and transmit the downlink message in accordance with the control signaling.

Some examples of the method, apparatuses, and non-transitory computer-readable medium described herein may further include operations, features, means, or instructions for receiving a signal indicating a UE capability associated with the set of phase tracking reference signal patterns, where the control signaling may be transmitted based on the UE capability.

In some examples of the method, apparatuses, and non-transitory computer-readable medium described herein, the signal may be received in a radio resource control message.

Some examples of the method, apparatuses, and non-transitory computer-readable medium described herein may further include operations, features, means, or instructions for receiving, based on transmitting the first one or more phase tracking reference signals and the second one or more phase tracking reference signals, a signal indicating one or more phase tracking reference signal patterns of the set of phase tracking reference signal patterns and transmitting, based on receiving the signal, a third one or more phase tracking reference signals according to a third pattern of the set of phase tracking reference signal patterns in a portion of a second transmission time interval.

Some examples of the method, apparatuses, and non-transitory computer-readable medium described herein may further include operations, features, means, or instructions for transmitting a lookup table identifying the set of phase tracking reference signal patterns, where the signal indicates the one or more phase tracking reference signal patterns based on the lookup table.

In some examples of the method, apparatuses, and non-transitory computer-readable medium described herein, the signal further indicates a quantity of symbols associated with the indicated one or more phase tracking reference signal patterns and the portion of the second transmission time interval includes the indicated quantity of symbols.

In some examples of the method, apparatuses, and non-transitory computer-readable medium described herein, the quantity of symbols may be indicated in one or more bits in the signal.

In some examples of the method, apparatuses, and non-transitory computer-readable medium described herein, the indicated one or more phase tracking reference signal patterns include the third pattern.

In some examples of the method, apparatuses, and non-transitory computer-readable medium described herein, the indicated one or more phase tracking reference signal patterns may be based on a channel delay spread, a back off associated with a fast Fourier transform operation, an integrated phase noise, or any combination thereof.

In some examples of the method, apparatuses, and non-transitory computer-readable medium described herein, the indicated one or more phase tracking reference signal patterns may be based on a signal to interference plus noise ratio, a rank indicator, a channel quality indicator, a modulation and coding scheme, a precoding matrix indicator, or any combination thereof.

In some examples of the method, apparatuses, and non-transitory computer-readable medium described herein, the signal may be received in a periodic report or an aperiodic report.

In some examples of the method, apparatuses, and non-transitory computer-readable medium described herein, the signal may be received in a physical uplink channel transmission or in a channel state feedback report.

In some examples of the method, apparatuses, and non-transitory computer-readable medium described herein, the control signaling includes a radio resource control message, a medium access control control element, a downlink control information message, or any combination thereof.

### BRIEF DESCRIPTION OF THE DRAWINGS

FIG. 1 illustrates an example of a wireless communications system that supports techniques for configuring phase tracking reference signal transmissions in accordance with aspects of the present disclosure.

FIG. 2 illustrates an example of a wireless communications system that supports techniques for configuring phase tracking reference signal transmissions in accordance with aspects of the present disclosure.

FIG. 3 illustrates an example of a downlink signal that supports techniques for configuring phase tracking reference signal transmissions in accordance with aspects of the present disclosure.

FIG. 4 illustrates an example of a transmission scheme that supports techniques for configuring phase tracking reference signal transmissions in accordance with aspects of the present disclosure.

FIG. 5 illustrates an example of a process flow that supports techniques for configuring phase tracking reference signal transmissions in accordance with aspects of the present disclosure.

FIGS. 6 and 7 show block diagrams of devices that support techniques for configuring phase tracking reference signal transmissions in accordance with aspects of the present disclosure.

FIG. 8 shows a block diagram of a communications manager that supports techniques for configuring phase tracking reference signal transmissions in accordance with aspects of the present disclosure.

FIG. 9 shows a diagram of a system including a device that supports techniques for configuring phase tracking reference signal transmissions in accordance with aspects of the present disclosure.

FIGS. 10 and 11 show block diagrams of devices that support techniques for configuring phase tracking reference signal transmissions in accordance with aspects of the present disclosure.

FIG. 12 shows a block diagram of a communications manager that supports techniques for configuring phase tracking reference signal transmissions in accordance with aspects of the present disclosure.

FIG. 13 shows a diagram of a system including a device that supports techniques for configuring phase tracking reference signal transmissions in accordance with aspects of the present disclosure.

FIGS. 14 through 18 show flowcharts illustrating methods that support techniques for configuring phase tracking reference signal transmissions in accordance with aspects of the present disclosure.

### DETAILED DESCRIPTION

In some wireless communications systems, Doppler shift and phase noise may impair signaling. The impairment may be represented as a multiplication by a rotating phasor in a time domain. To enable a user equipment (UE) to track a phase of transmissions, a base station may transmit a phase tracking reference signal (PTRS) or a set of PTRSs according to a pattern in the time domain. In some cases, the base station may apply a back-off to a signal before a fast Fourier transform (FFT) operation to reduce inter-symbol interference (ISI) and track dynamic timing changes to the signal after it is transmitted to the UE. The FFT back-off may introduce an effect of a circular shift in the rotating phasor. In some cases, the circular shift may reduce a reliability of phase noise estimation for transmissions based on the PTRS pattern.

According to the techniques described herein, a base station may configure multiple PTRS patterns in a single time interval (e.g., a slot) to improve phase tracking and phase noise estimation by the UE. The base station may transmit control signaling indicating multiple PTRS patterns for the time interval, and a UE may monitor for PTRSs in the time interval according to the indicated patterns to estimate a phase for receiving a downlink message from the base station. In some examples, the UE may signal a list of preferred PTRS patterns for the base station to use based on channel conditions. For example, the UE may transmit a report indicating one or more preferred PTRS patterns and a respective quantity of symbols in which the base station is to use each pattern.

Aspects of the disclosure are initially described in the context of wireless communications systems. Aspects of the disclosure are further illustrated by and described with reference to a process flow, apparatus diagrams, system diagrams, and flowcharts that relate to techniques for configuring phase tracking reference signal transmissions.

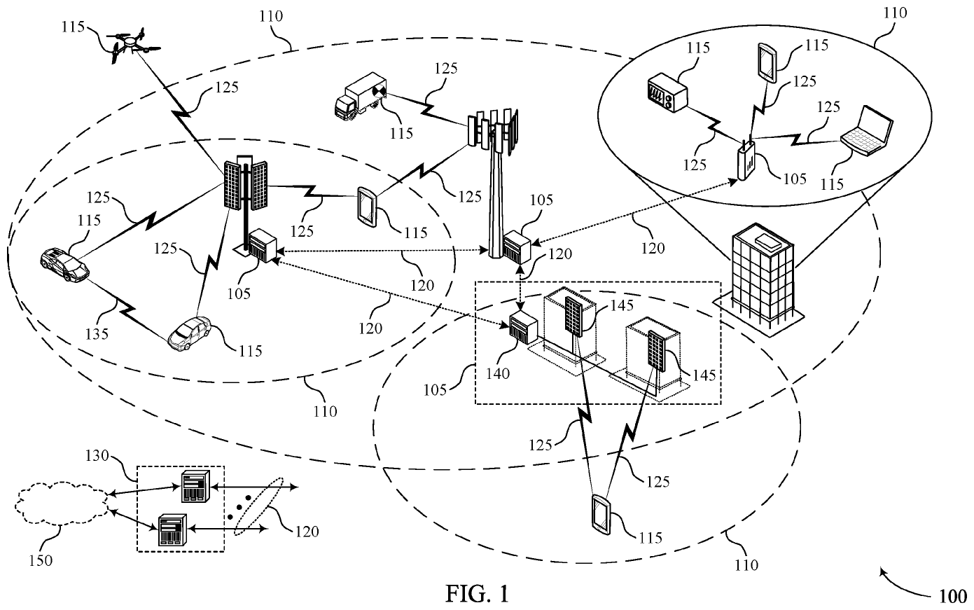

FIG. 1 illustrates an example of a wireless communications system 100 that supports techniques for configuring phase tracking reference signal transmissions in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Ts=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

According to the techniques described herein, a base station 105 may configure multiple PTRS patterns in a single time interval (e.g., a TTI, such as a slot) to improve phase tracking and phase noise estimation. The base station 105 may transmit control signaling indicating multiple PTRS patterns for the time interval, and a UE 115 may monitor for PTRSs in the time interval according to the indicated patterns to estimate a phase for receiving a downlink message from the base station 105. In some examples, the UE 115 may signal a list of preferred PTRS patterns for the base station 105 to use based on channel conditions. For example, the UE 115 may transmit a report indicating one or more preferred PTRS patterns and a respective quantity of symbols in which the base station 105 is to use each pattern.

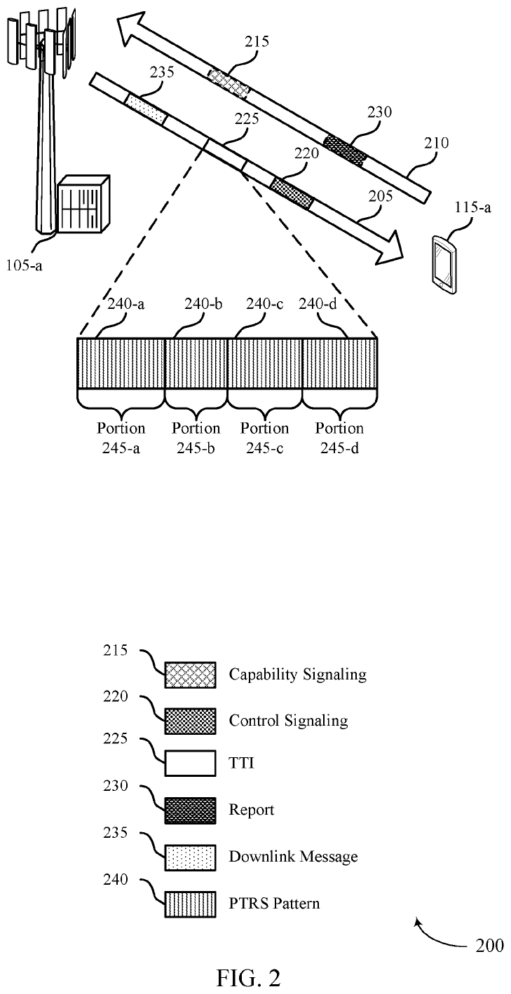

FIG. 2 illustrates an example of a wireless communications system 200 that supports techniques for configuring phase tracking reference signal transmissions in accordance with aspects of the present disclosure. In some examples, the wireless communications system 200 may implement aspects of the wireless communications system 100. For example, the wireless communications system 200 may include a base station 105-a and a UE 115-a, which may be examples of the corresponding devices described with reference to FIG. 1. The wireless communications system 200 may include features for improved phase tracking for communications between the UE 115-a and the base station 105-a.

The base station 105-a and the UE 115-a may communicate via one or more channels. For example, the base station 105-a may transmit signaling to the UE 115-a via a downlink channel 205, and the UE 115-a may transmit signaling to the base station 105-a via an uplink channel 210. The downlink channel 205 and the uplink channel 210 may each be associated with a bandwidth of a frequency range (e.g., Frequency Range 4 (FR4), which may include bands between 52.6 GHz and 114.25 GHZ, or Frequency Range 5 (FR5), which may include bands between 114.25 GHz and 300 GHz, where bands of FR4 and FR5 may be referred to as sub-terahertz (THz) bands). In some examples, communications using higher bandwidth signals and higher data rates may increase power consumption at the UE 115-a and increase integrated phase noise.

In some examples, OFDM waveforms may provide advantages to the downlink channel 205 and the uplink channel 210, including high throughputs, channel robustness (e.g., by improving efficiency in channel fading), MIMO, etc., but may also increase power consumption compared to other waveforms. For example, time domain waveforms may reduce power consumption and mitigate phase noise with low complexity using time domain PTRS transmissions. Additionally or alternatively, a DFT-S-OFDM waveform may mitigate ISI using frequency equalization and mitigate inter-cell interference (ICI) using time domain phase noise estimation. The DFT-S-OFDM waveform may be used on the uplink channel 210 or the downlink channel 205. In some examples, time domain PTRSs may be transmitted according to one or more PTRS patterns 240. Some PTRS patterns 240 may increase signaling overhead or impair phase noise estimation, for example when a sampling offset is used based on channel conditions or back-off for ISI reduction.

In some cases, Doppler shift and phase noise may impair signaling on the downlink channel 205 (and, in some cases, the uplink channel 210). The impairment may be represented as a multiplication by a rotating phasor in a time domain. To enable the UE 115-a to track a phase of transmissions via the downlink channel 205, the base station 105-a may transmit a TTI 225 that includes a set of PTRSs according to a PTRS pattern 240 in the time domain. In some cases, the base station 105-a may apply a back-off to a signal before a FFT operation to reduce ISI and track dynamic timing changes to the signal after it is transmitted to the UE 115-a. The FFT back-off may introduce an effect of a circular shift in the rotating phasor. In some cases, the circular shift may reduce a reliability of phase noise estimation for transmissions based on the PTRS pattern 240. For example, some patterns may be sensitive to a timing, where a first group of PTRSs and a last group of PTRSs in a time interval (e.g., a TTI 225, such as a slot) may indicate a same phase, which may reduce accuracy of the estimation of the phase noise and the Doppler shift. In some examples, it may be difficult to efficiently balance a processing gain based on measuring the PTRSs and a signaling overhead associated with transmitting the PTRSs. For example, changes in conditions (e.g., a signal-to-noise ratio (SNR)) of the downlink channel 205 may impact the balance.

As described herein, the base station 105-a may configure multiple PTRS patterns 240 in the TTI 225 to improve phase tracking and phase noise estimation at the UE 115-a. In some examples, the UE 115-a may transmit capability signaling 215 (e.g., in an RRC message) reporting to the base station 105-a of a capability to support multiple PTRS patterns 240 in the same TTI 225. The base station 105-a may transmit control signaling 220 indicating multiple PTRS patterns 240 for the TTI 225, and the UE 115-a may monitor for PTRSs in each portion 245 (e.g., portions 245-a through 245-d, which may each include an identified quantity of symbol periods) of the TTI 225 according to the respective indicated PTRS pattern 240 (e.g., PTRS patterns 240-a through 240-d) for the portion 245 to estimate a phase for receiving a downlink message 235 from the base station 105-a.

In some examples, the UE 115-a may signal a list of preferred PTRS patterns 240 for the base station 105-a to use based on conditions of the downlink channel 205. For example, the UE 115-a may transmit a report 230 indicating one or more preferred PTRS patterns 240, such as based on a lookup table at the UE 115-a. The UE 115-a may further indicate a respective quantity of symbols (e.g., corresponding to a respective portion 245) in which the base station 105-a is to use each PTRS pattern 240, which may be represented by one or more bits in the report 230. In some examples, the report 230 may be transmitted in a physical uplink shared channel (PUSCH) transmission. In some examples, the UE 115-a may indicate a single PTRS pattern 240 in the report 230, where the single PTRS pattern 240 may maximize performance of the phase estimation at the UE 115-a.

In some examples, the UE 115-a may determine the one or more preferred PTRS patterns 240 based on a channel delay spread, which may affect a time domain offset associated with the TTI 225. Additionally or alternatively, the one or more preferred PTRS patterns 240 may be based on the back-off applied before the FFT operation or an integrated phase noise, where the integrated phase noise may affect a signal-to-interference-plus-noise ratio (SINR) of one or more data samples based on an extrapolation of the estimated phase noise. Additionally or alternatively, the one or more preferred PTRS patterns 240 may be based on one or more parameters of the downlink channel 205, including an SINR, a rank indicator (RI), a channel quality indicator (CQI), a modulation and coding scheme (MCS), a precoding matrix indicator (PMI), or any combination thereof (e.g., as these parameters may influence the ability of a code to correct errors due to bad PTRS). In some examples, the UE 115-a may transmit the report 230 periodically or aperiodically, for example as configured by the base station 105-a. In some examples, the UE 115-a may transmit the report 230 in a PUSCH transmission, a physical uplink control channel (PUCCH) transmission, a channel state feedback report (e.g., a channel state information (CSI) report), or any combination thereof. In response to the report 230, the base station 105-a may transmit control signaling 220 (e.g., a downlink control information (DCI) message, or a MAC control element (MAC-CE)) indicating one or more PTRS patterns 240 to be used in a subsequent time interval (e.g., a subsequent TTI 225), where the indicated patterns may be based on or include the one or more preferred PTRS patterns 240. For example, the base station 105-a may transmit in a DCI message one bit indicating the one or more preferred PTRS patterns 240 are to be used, or a bit may be added to a DCI, MAC-CE, or other control message (e.g., for K0>0) the list of PTRS patterns being used).

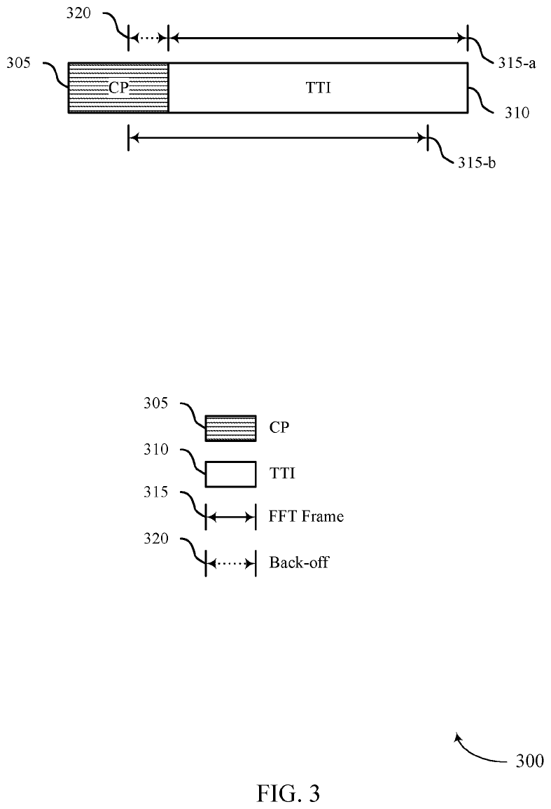

FIG. 3 illustrates an example of a downlink signal 300 that supports techniques for configuring phase tracking reference signal transmissions in accordance with aspects of the present disclosure. In some examples, the downlink signal 300 may implement aspects of wireless communications systems 100 and 200. For example, the downlink signal 300 may be transmitted from a base station to a UE, which may be examples of corresponding devices described with reference to FIGS. 1 and 2. Aspects of the downlink signal 300 may support improvement to phase estimation operations at the UE and, in some examples, may promote improvements to efficiency and reliability for communications between the base station and the UE, among other benefits.

In some cases, Doppler shift and phase noise may impair signaling on a downlink channel, which may carry the downlink signal 300. The impairment may be represented as a multiplication by a rotating phasor in a time domain. To enable the UE to track a phase of transmissions via the downlink channel, the base station may transmit a TTI 310 that includes a set of PTRSs according to a PTRS pattern in the time domain. The UE may be configured to estimate the phase based on PTRSs in an FFT frame 315-a, which may correspond to the TTI 310. The downlink signal 300 may additionally include a cyclic prefix (CP) 305, which the base station may transmit to reduce ISI and ICI for the downlink signal 300.

In some cases, the base station may apply a back-off 320 to the downlink signal 300 before an FFT operation to reduce ISI and track dynamic timing changes to the downlink signal 300 after it is transmitted to the UE. Based on the back-off 320, the UE may estimate the phase based on PTRSs in a shifted FFT frame 315-b. The back-off 320 and the resulting shifted FFT frame 315-b may introduce an effect of a circular shift in the rotating phasor. In some cases, the circular shift may reduce a reliability of phase noise estimation for transmissions based on the PTRS pattern. For example, some patterns may be sensitive to a timing, where a first group of PTRSs and a last group of PTRSs in the TTI 310 (e.g., a slot) may indicate a same phase, which may reduce accuracy of the estimation of the phase noise and the Doppler shift. In some examples, it may be difficult to efficiently balance a processing gain based on measuring the PTRSs and a signaling overhead associated with transmitting the downlink signal 300 to provide the PTRSs. For example, changes in conditions (e.g., an SNR) of the downlink channel may impact the balance.

As described herein, the base station may configure multiple PTRS patterns in the TTI 310 to improve phase tracking and phase noise estimation at the UE. In some examples, the UE may transmit capability signaling (e.g., in an RRC message) reporting to the base station of a capability to support multiple PTRS patterns in the same TTI 310. The base station may transmit control signaling indicating multiple PTRS patterns for the TTI 310, and the UE may monitor for PTRSs in each portion of the TTI 310 according to the respective indicated PTRS pattern for the portion of the TTI 310 to estimate a phase for receiving a subsequent downlink message from the base station.

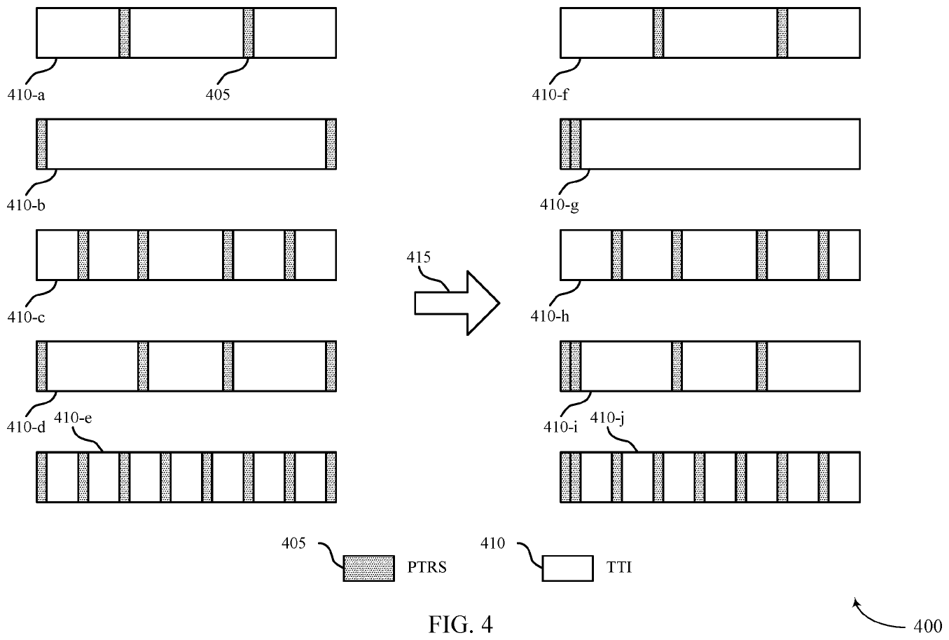

FIG. 4 illustrates an example of a transmission scheme 400 that supports techniques for configuring phase tracking reference signal transmissions in accordance with aspects of the present disclosure. In some examples, the transmission scheme 400 may implement aspects of wireless communications systems 100 and 200. For example, the transmission scheme 400 may illustrate TTIs 410 transmitted from a base station to a UE, which may be examples of corresponding devices described with reference to FIGS. 1 and 2. Aspects of the transmission scheme 400 may support improvement to phase estimation operations at the UE and, in some examples, may promote improvements to efficiency and reliability for communications between the base station and the UE, among other benefits.

In some cases, Doppler shift and phase noise may impair signaling on a downlink channel, which may carry one or more TTIs 410. The impairment may be represented as a multiplication by a rotating phasor in a time domain. To enable the UE to track a phase of transmissions via the downlink channel, the base station may transmit a TTI 410 that includes a set of PTRSs 405 according to a pattern in the time domain. The UE may be configured to estimate the phase based on the PTRSs 405 in an FFT frame, which may correspond to the TTI 410. As illustrated in FIG. 4, each of TTIs 410-a through 410-e may include an example pattern of PTRSs 405 for estimating and tracking the phase of transmissions. Some patterns (e.g., the patterns illustrated in TTIs 410-a and 410-c) may be sensitive to extrapolation in the FFT frame, and other patterns (e.g., the patterns illustrated in TTIs 410-b, 410-d, and 410-e) may be sensitive to a timing of the FFT frame.

In some cases, the base station may apply a back-off to a signal before an FFT operation to reduce ISI and track dynamic timing changes to the signal after it is transmitted to the UE. Based on the back-off, the UE may estimate the phase based on PTRSs 405 in a shifted FFT frame. The back-off and the resulting shifted FFT frame may introduce an effect of a circular shift 415 in the rotating phasor. As illustrated in FIG. 4, each of TTIs 410-f through 410-j may include an example pattern of PTRSs 405 that illustrate a shift based on the circular shift 415 from the patterns of PTRSs 405 in the TTIs 410-a through 410-e. That is, the TTI 410-f may illustrate a pattern of PTRSs 405 that are shifted from the pattern of PTRSs 405 illustrated in the TTI 410-a, the TTI 410-g may illustrate a pattern of PTRSs 405 that are shifted from the pattern of PTRSs 405 illustrated in the TTI 410-b, etc.

In some cases, the circular shift 415 may reduce a reliability of phase noise estimation for transmissions based on the patterns of PTRSs 405. For example, in some patterns (e.g., the timing-sensitive shifted patterns illustrated in TTIs 410-g, 410-i, and 410-j), a first group of PTRSs 405 and a last group of PTRSs 405 in the TTI 410 (e.g., a slot) may indicate a same phase, which may reduce accuracy of the estimation of the phase noise and the Doppler shift. In some examples, it may be difficult to efficiently balance a processing gain based on measuring the PTRSs 405 and a signaling overhead associated with transmitting the TTIs 410 to provide the PTRSs 405. For example, changes in conditions (e.g., an SNR)) of the downlink channel may impact the balance.

As described herein, the base station may configure multiple patterns of PTRSs 405 for transmission in a same TTI 410 to improve phase tracking and phase noise estimation at the UE. In some examples, the UE may transmit capability signaling (e.g., in an RRC message) reporting to the base station of a capability to support multiple patterns in the same TTI 410. The base station may transmit control signaling indicating multiple patterns for the TTI 410, and the UE may monitor for PTRSs 405 in each portion of the TTI 410 according to the respective indicated pattern for the portion of the TTI 410 to estimate a phase for receiving a subsequent downlink message from the base station.

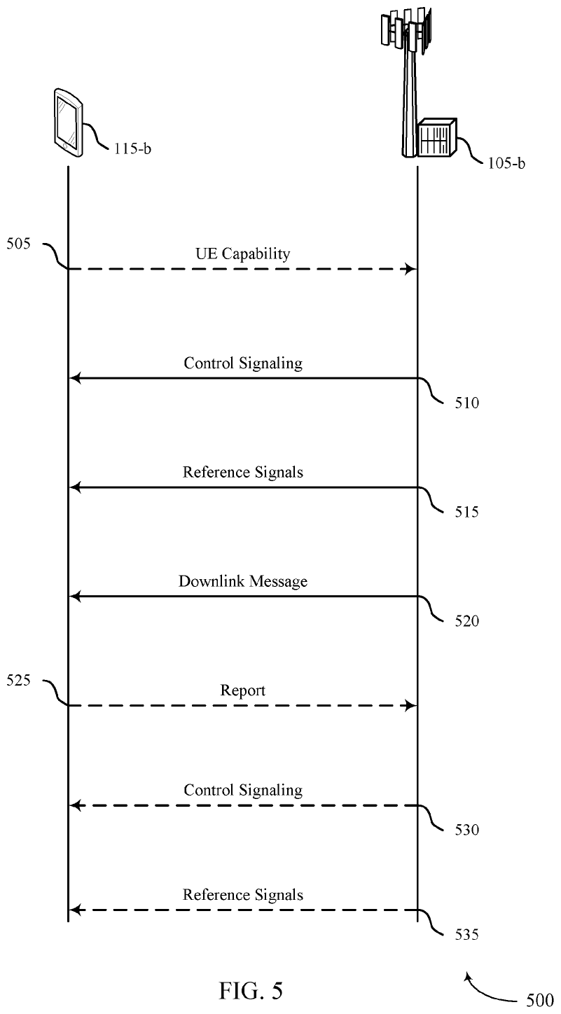

FIG. 5 illustrates an example of a process flow 500 that supports techniques for configuring phase tracking reference signal transmissions in accordance with aspects of the present disclosure. In some examples, the process flow 500 may implement aspects of wireless communications systems 100 and 200. For example, the process flow 500 may include example operations associated with one or more of a base station 105-b or a UE 115-b, which may be examples of the corresponding devices described with reference to FIGS. 1 and 2. In the following description of the process flow 500, the operations between the base station 105-b and the UE 115-b may be performed in a different order than the example order shown, or the operations performed by the base station 105-b and the UE 115-b may be performed in different orders or at different times. Some operations may also be omitted from the process flow 500, and other operations may be added to the process flow 500. The operations performed by the base station 105-b and the UE 115-b may support improvement to the UE 115-b phase estimation operations and, in some examples, may promote improvements to efficiency and reliability for communications between the base station 105-b and the UE 115-b, among other benefits.

In some examples, at 505, the UE 115-b may transmit a signal to the base station 105-b indicating a UE capability to support multiple PTRS patterns in a same time interval (e.g., a TTI, such as a slot). For example, the UE 115-b may transmit the signal in an RRC message.

At 510, the base station 105-b may transmit control signaling indicating multiple PTRS patterns for the time interval. In some examples, the control signaling may be transmitted in an RRC message, a DCI message, a MAC-CE, or any combination thereof. In some examples, the control signaling may be transmitted based on the UE capability.

At 515, the base station 105-b may transmit PTRSs according to multiple patterns in the time interval. For example, the base station 105-b may transmit a first one or more PTRSs according to a first pattern in a first portion of the time interval, and transmit a second one or more PTRSs according to a second pattern in a second portion of the time interval. Based on monitoring for the PTRS patterns, the UE 115-b may estimate a phase noise and a Doppler shift associated with a downlink channel. At 520, the UE 115-b may monitor for a downlink message from the base station 105-b within the time interval in which the PTRSs according to multiple patterns are also transmitted, and the UE may attempt to receive and decode the downlink message from the time interval based on the phase noise and Doppler shift estimates generated from the PTRSs according to multiple patterns within the time interval.

In some examples, at 525, the UE 115-b may signal a list of preferred PTRS patterns for the base station 105-b to use based on conditions of the downlink channel. For example, the UE 115-b may transmit a report indicating one or more preferred PTRS patterns, such as based on a lookup table at the UE 115-b. The UE 115-b may further indicate a respective quantity of symbols in which the base station 105-b is to use each pattern, which may be represented by one or more bits in the report. In some examples, the report may be transmitted in a PUSCH transmission. In some examples, the UE 115-b may indicate a single PTRS pattern in the report, where the single pattern may maximize performance of the phase estimation at the UE 115-b.

In some examples, the UE 115-b may determine the one or more preferred PTRS patterns based on a channel delay spread, a back-off applied before the FFT operation, or an integrated phase noise, or any combination thereof. Additionally or alternatively, the one or more preferred patterns may be based on one or more parameters of the downlink channel, including an SINR, an RI, a CQI, an MCS, a PMI, or any combination thereof. In some examples, the UE 115-b may transmit the report periodically or aperiodically, for example as configured by the base station 105-b. In some examples, the UE 115-b may transmit the report in a PUSCH transmission, a PUCCH transmission, a channel state feedback report (e.g., a CSI report), or any combination thereof.

In some examples, at 530, the base station 105-b may transmit control signaling in response to the report. The control signaling may indicate one or more PTRS patterns to be used in a subsequent time interval, where the indicated PTRS patterns may be based on or include the one or more preferred PTRS patterns. In some examples, the base station 105-b may transmit the control signaling in a DCI message, a MAC-CE, or both. For example, the base station 105-b may transmit in a DCI message one bit indicating the one or more preferred PTRS patterns are to be used.

In some examples, at 535, the UE 115-b may monitor for PTRSs in the subsequent time interval according to the PTRS patterns indicated by the base station 105-b. By implementing one or more of the described techniques, the UE 115-b may be able to estimate the phase noise and Doppler shift more efficiently, or in a manner that increases transmission reliability, or considers power consumption or processing load, among other benefits. For example, the described techniques may enable the base station 105-b to respond more quickly to changes in channel conditions by enabling the UE 115-b to signal the preferred PTRS patterns based on the channel conditions.

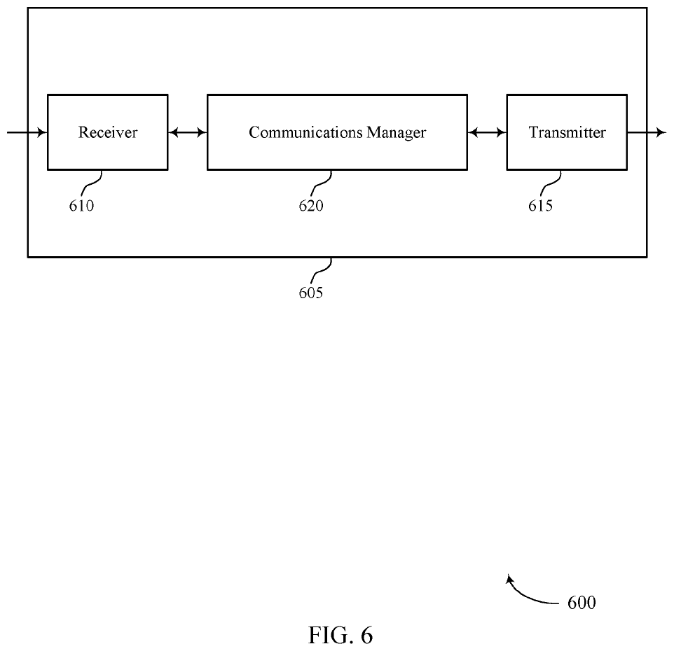

FIG. 6 shows a block diagram 600 of a device 605 that supports techniques for configuring phase tracking reference signal transmissions in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for configuring phase tracking reference signal transmissions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for configuring phase tracking reference signal transmissions). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for configuring phase tracking reference signal transmissions as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for receiving control signaling indicating a set of phase tracking reference signal patterns and scheduling transmission of a downlink message during a transmission time interval. The communications manager 620 may be configured as or otherwise support a means for monitoring, based on receiving the control signaling, for a first one or more phase tracking reference signals according to a first pattern of the set of phase tracking reference signal patterns in a first portion of the transmission time interval. The communications manager 620 may be configured as or otherwise support a means for monitoring, based on receiving the control signaling, for a second one or more phase tracking reference signals according to a second pattern of the set of phase tracking reference signal patterns in a second portion of the transmission time interval. The communications manager 620 may be configured as or otherwise support a means for monitoring, in accordance with the control signaling, the transmission time interval for the downlink message based on a phase estimate determined using the first one or more phase tracking reference signals and the second one or more phase tracking reference signals.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced processing, reduced power consumption, more efficient utilization of communication resources, and improved phased estimation, among other examples.

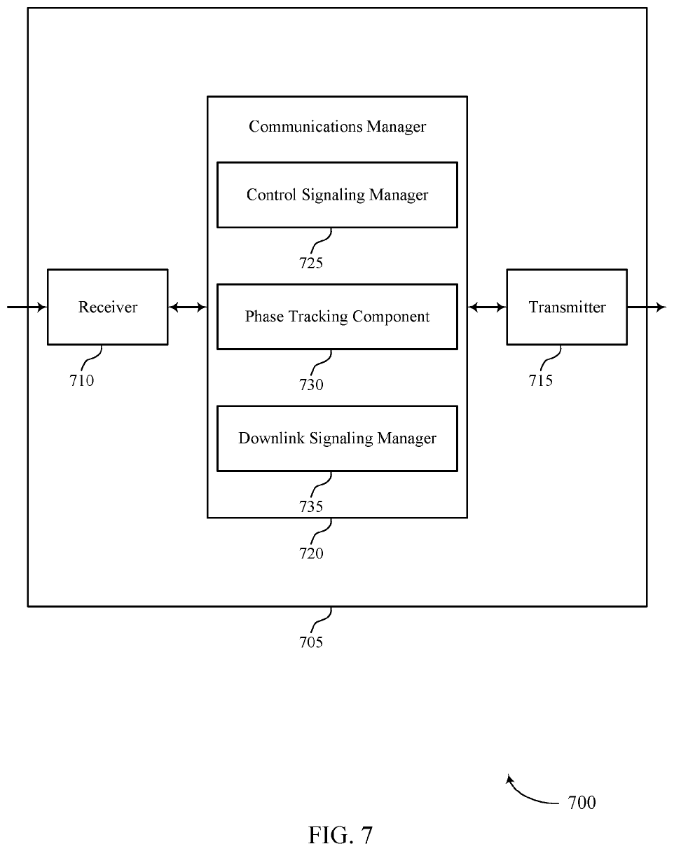

FIG. 7 shows a block diagram 700 of a device 705 that supports techniques for configuring phase tracking reference signal transmissions in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for configuring phase tracking reference signal transmissions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for configuring phase tracking reference signal transmissions). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for configuring phase tracking reference signal transmissions as described herein. For example, the communications manager 720 may include a control signaling manager 725, a phase tracking component 730, a downlink signaling manager 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The control signaling manager 725 may be configured as or otherwise support a means for receiving control signaling indicating a set of phase tracking reference signal patterns and scheduling transmission of a downlink message during a transmission time interval. The phase tracking component 730 may be configured as or otherwise support a means for monitoring, based on receiving the control signaling, for a first one or more phase tracking reference signals according to a first pattern of the set of phase tracking reference signal patterns in a first portion of the transmission time interval. The phase tracking component 730 may be configured as or otherwise support a means for monitoring, based on receiving the control signaling, for a second one or more phase tracking reference signals according to a second pattern of the set of phase tracking reference signal patterns in a second portion of the transmission time interval. The downlink signaling manager 735 may be configured as or otherwise support a means for monitoring, in accordance with the control signaling, the transmission time interval for the downlink message based on a phase estimate determined using the first one or more phase tracking reference signals and the second one or more phase tracking reference signals.

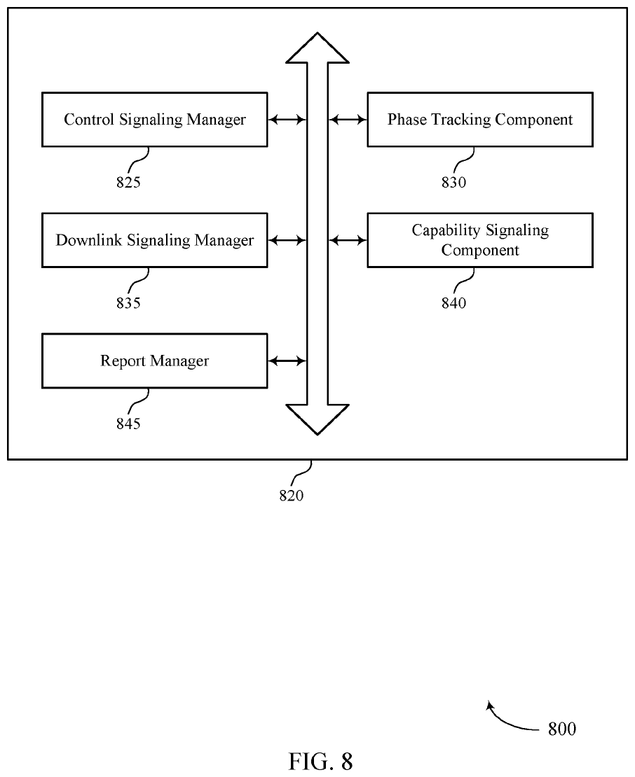

FIG. 8 shows a block diagram 800 of a communications manager 820 that supports techniques for configuring phase tracking reference signal transmissions in accordance with aspects of the present disclosure. The communications manager 820 may be an example of aspects of a communications manager 620, a communications manager 720, or both, as described herein. The communications manager 820, or various components thereof, may be an example of means for performing various aspects of techniques for configuring phase tracking reference signal transmissions as described herein. For example, the communications manager 820 may include a control signaling manager 825, a phase tracking component 830, a downlink signaling manager 835, a capability signaling component 840, a report manager 845, or any combination thereof. Each of these components may communicate, directly or indirectly, with one another (e.g., via one or more buses).

The communications manager 820 may support wireless communication at a UE in accordance with examples as disclosed herein. The control signaling manager 825 may be configured as or otherwise support a means for receiving control signaling indicating a set of phase tracking reference signal patterns and scheduling transmission of a downlink message during a transmission time interval. The phase tracking component 830 may be configured as or otherwise support a means for monitoring, based on receiving the control signaling, for a first one or more phase tracking reference signals according to a first pattern of the set of phase tracking reference signal patterns in a first portion of the transmission time interval. In some examples, the phase tracking component 830 may be configured as or otherwise support a means for monitoring, based on receiving the control signaling, for a second one or more phase tracking reference signals according to a second pattern of the set of phase tracking reference signal patterns in a second portion of the transmission time interval. The downlink signaling manager 835 may be configured as or otherwise support a means for monitoring, in accordance with the control signaling, the transmission time interval for the downlink message based on a phase estimate determined using the first one or more phase tracking reference signals and the second one or more phase tracking reference signals.

In some examples, the capability signaling component 840 may be configured as or otherwise support a means for transmitting a signal indicating a UE capability associated with the set of phase tracking reference signal patterns, where the control signaling is received based on the UE capability.

In some examples, the signal is transmitted in a radio resource control message.

In some examples, the report manager 845 may be configured as or otherwise support a means for transmitting, based on monitoring for the first one or more phase tracking reference signals and the second one or more phase tracking reference signals, a signal indicating one or more phase tracking reference signal patterns of the set of phase tracking reference signal patterns. In some examples, the phase tracking component 830 may be configured as or otherwise support a means for monitoring, based on transmitting the signal, for a third one or more phase tracking reference signals according to a third pattern of the set of phase tracking reference signal patterns in a portion of a second transmission time interval.

In some examples, the control signaling manager 825 may be configured as or otherwise support a means for receiving a lookup table identifying the set of phase tracking reference signal patterns, where the signal indicates the one or more phase tracking reference signal patterns based on the lookup table.

In some examples, the signal further indicates a quantity of symbols associated with the indicated one or more phase tracking reference signal patterns. In some examples, the portion of the second transmission time interval includes the indicated quantity of symbols.

In some examples, the quantity of symbols are indicated in one or more bits in the signal.

In some examples, the indicated one or more phase tracking reference signal patterns include the third pattern.

In some examples, the indicated one or more phase tracking reference signal patterns are based on a channel delay spread, a back off associated with a fast Fourier transform operation, an integrated phase noise, or any combination thereof.

In some examples, the indicated one or more phase tracking reference signal patterns are based on a signal to interference plus noise ratio, a rank indicator, a channel quality indicator, a modulation and coding scheme, a precoding matrix indicator, or any combination thereof.

In some examples, the signal is transmitted in a periodic report or an aperiodic report.

In some examples, the signal is transmitted in a physical uplink channel transmission or in a channel state feedback report.

In some examples, the control signaling includes a radio resource control message, a medium access control control element, a downlink control information message, or any combination thereof.

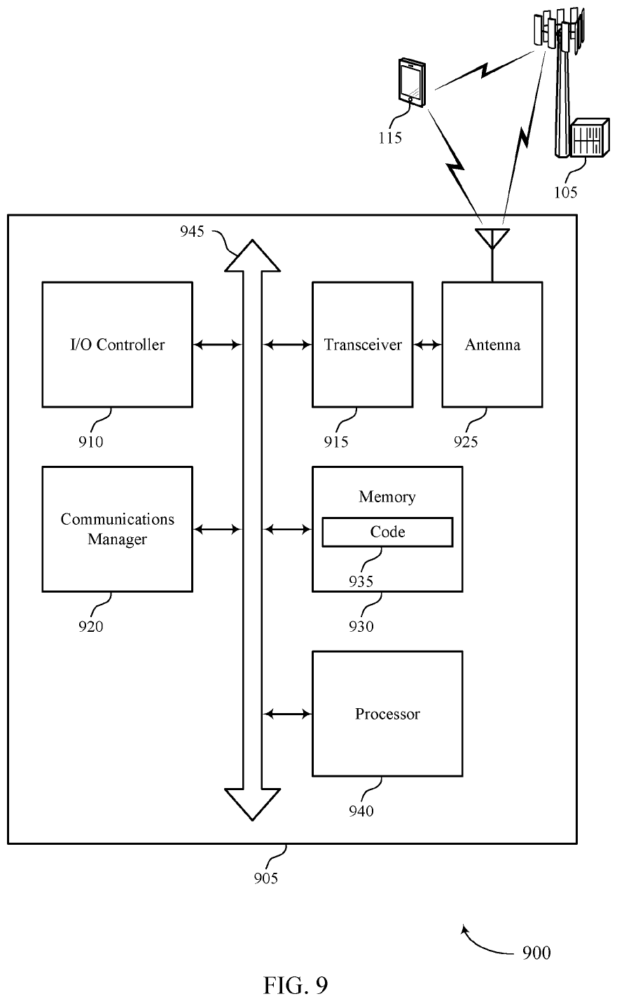

FIG. 9 shows a diagram of a system 900 including a device 905 that supports techniques for configuring phase tracking reference signal transmissions in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for configuring phase tracking reference signal transmissions). For example, the device 905 or a component of the device 905 may include a processor 940 and memory 930 coupled to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving control signaling indicating a set of phase tracking reference signal patterns and scheduling transmission of a downlink message during a transmission time interval. The communications manager 920 may be configured as or otherwise support a means for monitoring, based on receiving the control signaling, for a first one or more phase tracking reference signals according to a first pattern of the set of phase tracking reference signal patterns in a first portion of the transmission time interval. The communications manager 920 may be configured as or otherwise support a means for monitoring, based on receiving the control signaling, for a second one or more phase tracking reference signals according to a second pattern of the set of phase tracking reference signal patterns in a second portion of the transmission time interval. The communications manager 920 may be configured as or otherwise support a means for monitoring, in accordance with the control signaling, the transmission time interval for the downlink message based on a phase estimate determined using the first one or more phase tracking reference signals and the second one or more phase tracking reference signals.

By including or configuring the communications manager 920 in accordance with examples as described herein, the device 905 may support techniques for communication reliability, reduced latency, improved user experience related to reduced processing, reduced power consumption, more efficient utilization of communication resources, improved coordination between devices, longer battery life, improved utilization of processing capability, and improved phase estimation.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for configuring phase tracking reference signal transmissions as described herein, or the processor 940 and the memory 930 may be otherwise configured to perform or support such operations.

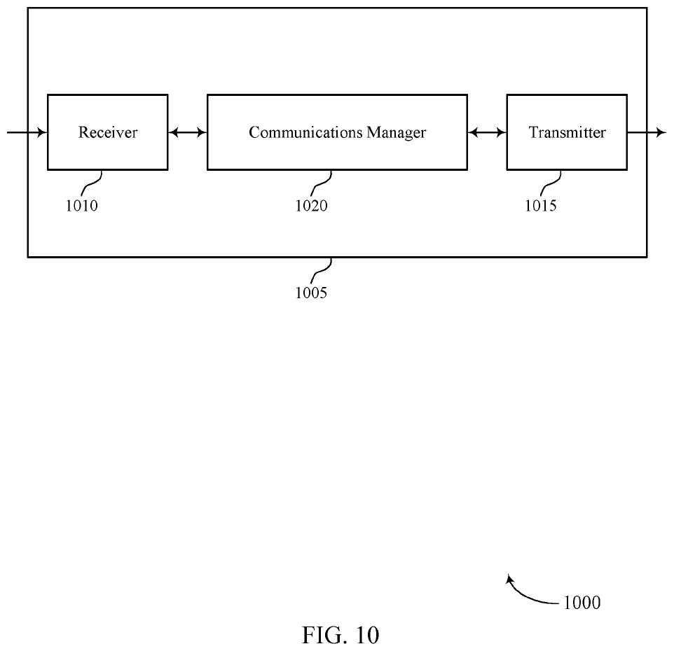

FIG. 10 shows a block diagram 1000 of a device 1005 that supports techniques for configuring phase tracking reference signal transmissions in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for configuring phase tracking reference signal transmissions). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for configuring phase tracking reference signal transmissions). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of techniques for configuring phase tracking reference signal transmissions as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a base station in accordance with examples as disclosed herein. For example, the communications manager 1020 may be configured as or otherwise support a means for transmitting, to a UE, control signaling indicating a set of phase tracking reference signal patterns and scheduling transmission of a downlink message during a transmission time interval. The communications manager 1020 may be configured as or otherwise support a means for transmitting, based on transmitting the control signaling, a first one or more phase tracking reference signals according to a first pattern of the set of phase tracking reference signal patterns in a first portion of the transmission time interval. The communications manager 1020 may be configured as or otherwise support a means for transmitting, based on transmitting the control signaling, a second one or more phase tracking reference signals according to a second pattern of the set of phase tracking reference signal patterns in a second portion of the transmission time interval. The communications manager 1020 may be configured as or otherwise support a means for transmitting the downlink message in accordance with the control signaling.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced processing, reduced power consumption, more efficient utilization of communication resources, and improved phase estimation.

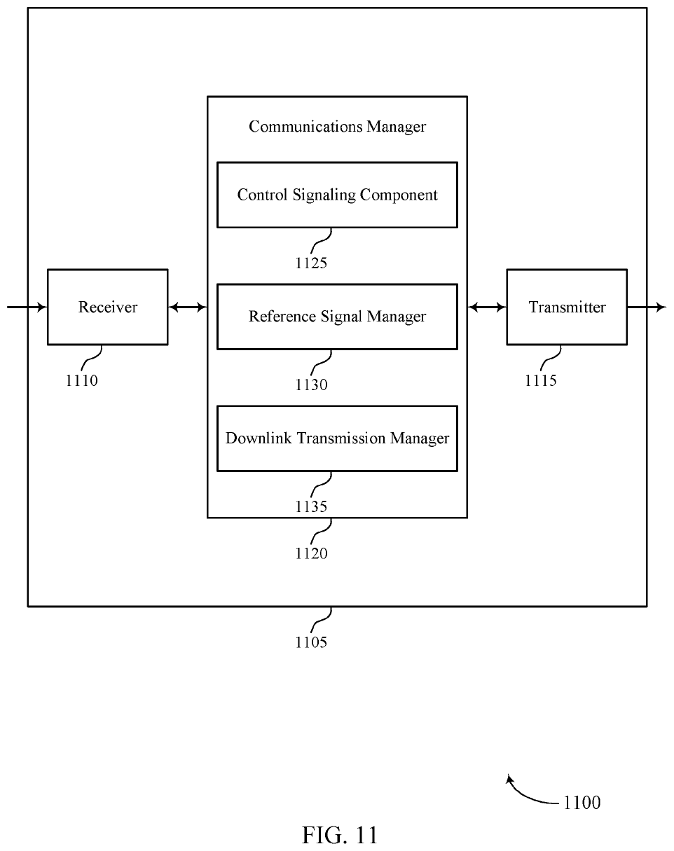

FIG. 11 shows a block diagram 1100 of a device 1105 that supports techniques for configuring phase tracking reference signal transmissions in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for configuring phase tracking reference signal transmissions). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for configuring phase tracking reference signal transmissions). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of techniques for configuring phase tracking reference signal transmissions as described herein. For example, the communications manager 1120 may include a control signaling component 1125, a reference signal manager 1130, a downlink transmission manager 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a base station in accordance with examples as disclosed herein. The control signaling component 1125 may be configured as or otherwise support a means for transmitting, to a UE, control signaling indicating a set of phase tracking reference signal patterns and scheduling transmission of a downlink message during a transmission time interval. The reference signal manager 1130 may be configured as or otherwise support a means for transmitting, based on transmitting the control signaling, a first one or more phase tracking reference signals according to a first pattern of the set of phase tracking reference signal patterns in a first portion of the transmission time interval. The reference signal manager 1130 may be configured as or otherwise support a means for transmitting, based on transmitting the control signaling, a second one or more phase tracking reference signals according to a second pattern of the set of phase tracking reference signal patterns in a second portion of the transmission time interval. The downlink transmission manager 1135 may be configured as or otherwise support a means for transmitting the downlink message in accordance with the control signaling.

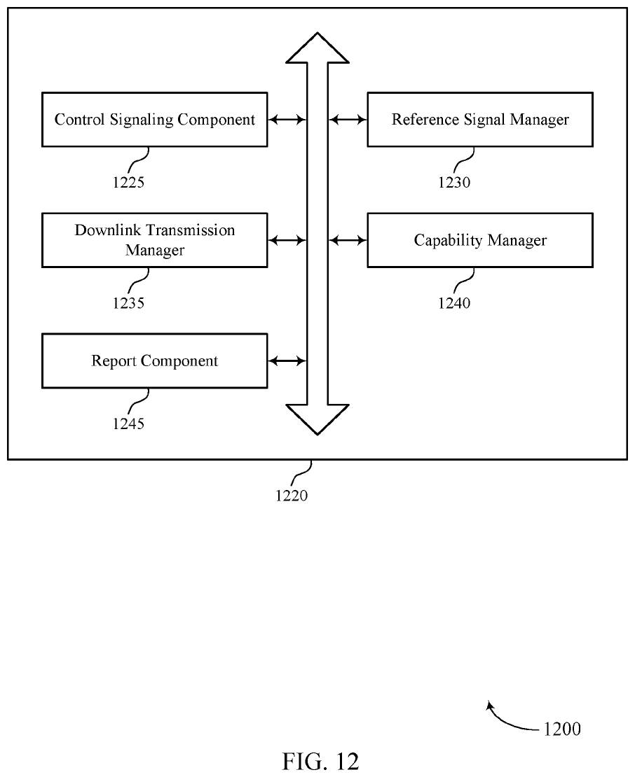

FIG. 12 shows a block diagram 1200 of a communications manager 1220 that supports techniques for configuring phase tracking reference signal transmissions in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of techniques for configuring phase tracking reference signal transmissions as described herein. For example, the communications manager 1220 may include a control signaling component 1225, a reference signal manager 1230, a downlink transmission manager 1235, a capability manager 1240, a report component 1245, or any combination thereof. Each of these components may communicate, directly or indirectly, with one another (e.g., via one or more buses).

The communications manager 1220 may support wireless communication at a base station in accordance with examples as disclosed herein. The control signaling component 1225 may be configured as or otherwise support a means for transmitting, to a UE, control signaling indicating a set of phase tracking reference signal patterns and scheduling transmission of a downlink message during a transmission time interval. The reference signal manager 1230 may be configured as or otherwise support a means for transmitting, based on transmitting the control signaling, a first one or more phase tracking reference signals according to a first pattern of the set of phase tracking reference signal patterns in a first portion of the transmission time interval. In some examples, the reference signal manager 1230 may be configured as or otherwise support a means for transmitting, based on transmitting the control signaling, a second one or more phase tracking reference signals according to a second pattern of the set of phase tracking reference signal patterns in a second portion of the transmission time interval. The downlink transmission manager 1235 may be configured as or otherwise support a means for transmitting the downlink message in accordance with the control signaling.

In some examples, the capability manager 1240 may be configured as or otherwise support a means for receiving a signal indicating a UE capability associated with the set of phase tracking reference signal patterns, where the control signaling is transmitted based on the UE capability.

In some examples, the signal is received in a radio resource control message.

In some examples, the report component 1245 may be configured as or otherwise support a means for receiving, based on transmitting the first one or more phase tracking reference signals and the second one or more phase tracking reference signals, a signal indicating one or more phase tracking reference signal patterns of the set of phase tracking reference signal patterns. In some examples, the reference signal manager 1230 may be configured as or otherwise support a means for transmitting, based on receiving the signal, a third one or more phase tracking reference signals according to a third pattern of the set of phase tracking reference signal patterns in a portion of a second transmission time interval.

In some examples, the control signaling component 1225 may be configured as or otherwise support a means for transmitting a lookup table identifying the set of phase tracking reference signal patterns, where the signal indicates the one or more phase tracking reference signal patterns based on the lookup table.

In some examples, the signal further indicates a quantity of symbols associated with the indicated one or more phase tracking reference signal patterns. In some examples, the portion of the second transmission time interval includes the indicated quantity of symbols.

In some examples, the quantity of symbols are indicated in one or more bits in the signal.

In some examples, the indicated one or more phase tracking reference signal patterns include the third pattern.

In some examples, the indicated one or more phase tracking reference signal patterns are based on a channel delay spread, a back off associated with a fast Fourier transform operation, an integrated phase noise, or any combination thereof.

In some examples, the indicated one or more phase tracking reference signal patterns are based on a signal to interference plus noise ratio, a rank indicator, a channel quality indicator, a modulation and coding scheme, a precoding matrix indicator, or any combination thereof.

In some examples, the signal is received in a periodic report or an aperiodic report.

In some examples, the signal is received in a physical uplink channel transmission or in a channel state feedback report.

In some examples, the control signaling includes a radio resource control message, a medium access control control element, a downlink control information message, or any combination thereof.

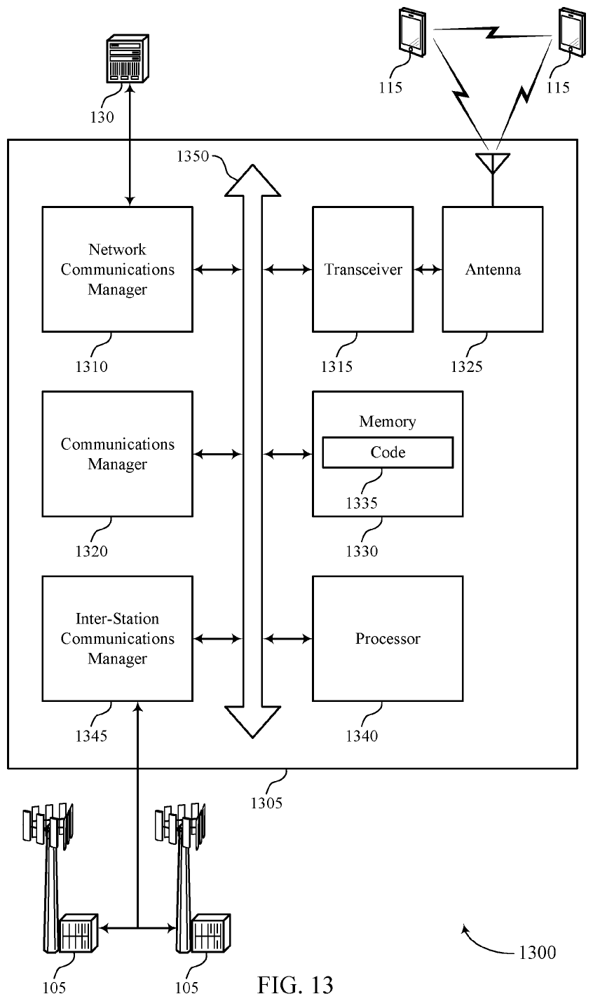

FIG. 13 shows a diagram of a system 1300 including a device 1305 that supports techniques for configuring phase tracking reference signal transmissions in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting techniques for configuring phase tracking reference signal transmissions). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communication at a base station in accordance with examples as disclosed herein. For example, the communications manager 1320 may be configured as or otherwise support a means for transmitting, to a UE, control signaling indicating a set of phase tracking reference signal patterns and scheduling transmission of a downlink message during a transmission time interval. The communications manager 1320 may be configured as or otherwise support a means for transmitting, based on transmitting the control signaling, a first one or more phase tracking reference signals according to a first pattern of the set of phase tracking reference signal patterns in a first portion of the transmission time interval. The communications manager 1320 may be configured as or otherwise support a means for transmitting, based on transmitting the control signaling, a second one or more phase tracking reference signals according to a second pattern of the set of phase tracking reference signal patterns in a second portion of the transmission time interval. The communications manager 1320 may be configured as or otherwise support a means for transmitting the downlink message in accordance with the control signaling.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, improved utilization of processing capability, and improved phase estimation.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of techniques for configuring phase tracking reference signal transmissions as described herein, or the processor 1340 and the memory 1330 may be otherwise configured to perform or support such operations.

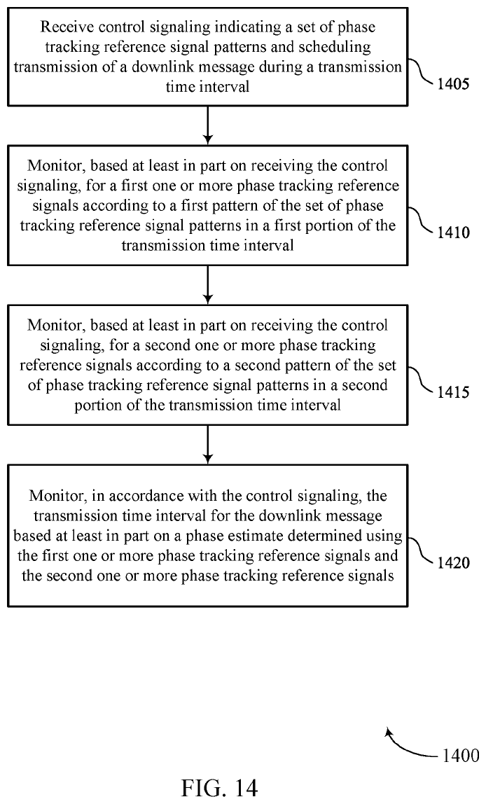

FIG. 14 shows a flowchart illustrating a method 1400 that supports techniques for configuring phase tracking reference signal transmissions in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving control signaling indicating a set of phase tracking reference signal patterns and scheduling transmission of a downlink message during a transmission time interval. The operations of 1405 may be performed in accordance with examples as disclosed herein. In some examples, aspects of the operations of 1405 may be performed by a control signaling manager 825 as described with reference to FIG. 8.

At 1410, the method may include monitoring, based at least in part on receiving the control signaling, for a first one or more phase tracking reference signals according to a first pattern of the set of phase tracking reference signal patterns in a first portion of the transmission time interval. The operations of 1410 may be performed in accordance with examples as disclosed herein. In some examples, aspects of the operations of 1410 may be performed by a phase tracking component 830 as described with reference to FIG. 8.

At 1415, the method may include monitoring, based at least in part on receiving the control signaling, for a second one or more phase tracking reference signals according to a second pattern of the set of phase tracking reference signal patterns in a second portion of the transmission time interval. The operations of 1415 may be performed in accordance with examples as disclosed herein. In some examples, aspects of the operations of 1415 may be performed by a phase tracking component 830 as described with reference to FIG. 8.

At 1420, the method may include monitoring, in accordance with the control signaling, the transmission time interval for the downlink message based at least in part on a phase estimate determined using the first one or more phase tracking reference signals and the second one or more phase tracking reference signals. The operations of 1420 may be performed in accordance with examples as disclosed herein. In some examples, aspects of the operations of 1420 may be performed by a downlink signaling manager 835 as described with reference to FIG. 8.

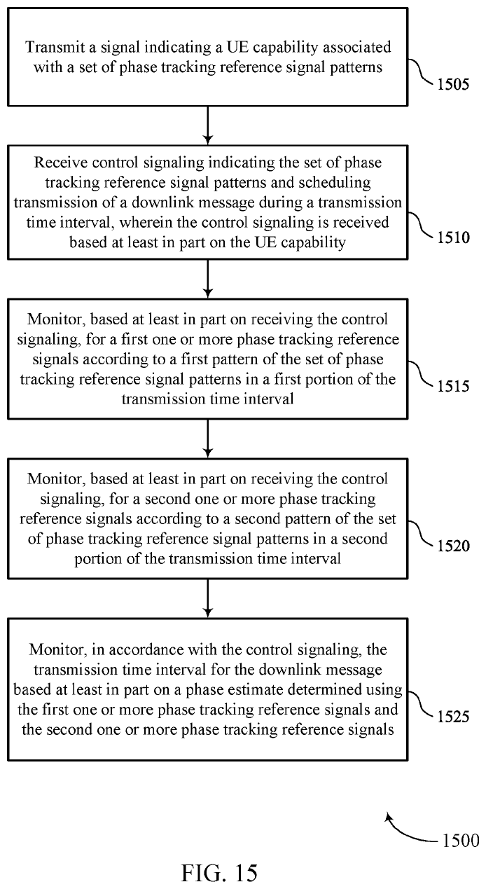

FIG. 15 shows a flowchart illustrating a method 1500 that supports techniques for configuring phase tracking reference signal transmissions in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include transmitting a signal indicating a UE capability associated with a set of phase tracking reference signal patterns. The operations of 1505 may be performed in accordance with examples as disclosed herein. In some examples, aspects of the operations of 1505 may be performed by a capability signaling component 840 as described with reference to FIG. 8.

At 1510, the method may include receiving control signaling indicating the set of phase tracking reference signal patterns and scheduling transmission of a downlink message during a transmission time interval, wherein the control signaling is received based at least in part on the UE capability. The operations of 1510 may be performed in accordance with examples as disclosed herein. In some examples, aspects of the operations of 1510 may be performed by a control signaling manager 825 as described with reference to FIG. 8.

At 1515, the method may include monitoring, based at least in part on receiving the control signaling, for a first one or more phase tracking reference signals according to a first pattern of the set of phase tracking reference signal patterns in a first portion of the transmission time interval. The operations of 1515 may be performed in accordance with examples as disclosed herein. In some examples, aspects of the operations of 1515 may be performed by a phase tracking component 830 as described with reference to FIG. 8.

At 1520, the method may include monitoring, based at least in part on receiving the control signaling, for a second one or more phase tracking reference signals according to a second pattern of the set of phase tracking reference signal patterns in a second portion of the transmission time interval. The operations of 1520 may be performed in accordance with examples as disclosed herein. In some examples, aspects of the operations of 1520 may be performed by a phase tracking component 830 as described with reference to FIG. 8.

At 1525, the method may include monitoring, in accordance with the control signaling, the transmission time interval for the downlink message based at least in part on a phase estimate determined using the first one or more phase tracking reference signals and the second one or more phase tracking reference signals. The operations of 1525 may be performed in accordance with examples as disclosed herein. In some examples, aspects of the operations of 1525 may be performed by a downlink signaling manager 835 as described with reference to FIG. 8.

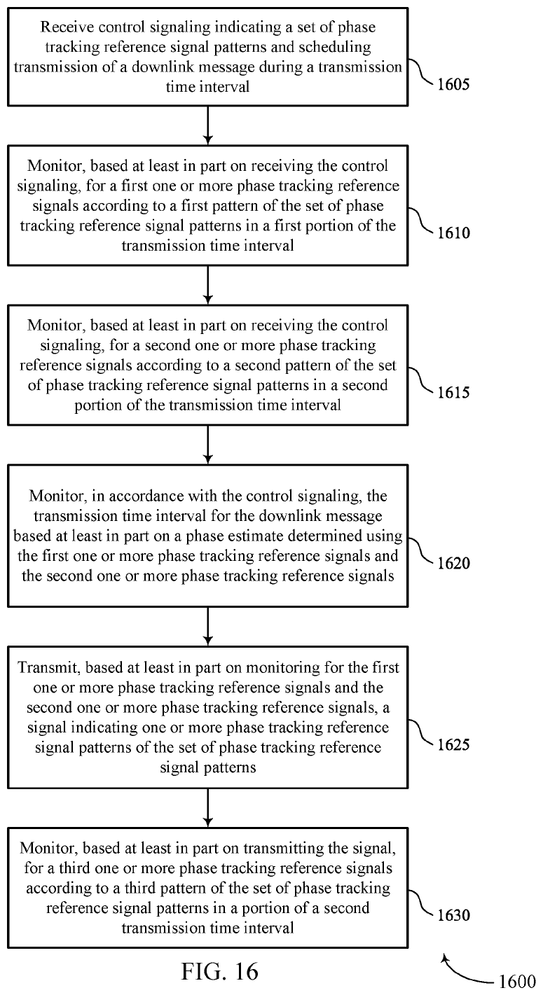

FIG. 16 shows a flowchart illustrating a method 1600 that supports techniques for configuring phase tracking reference signal transmissions in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1605, the method may include receiving control signaling indicating a set of phase tracking reference signal patterns and scheduling transmission of a downlink message during a transmission time interval. The operations of 1605 may be performed in accordance with examples as disclosed herein. In some examples, aspects of the operations of 1605 may be performed by a control signaling manager 825 as described with reference to FIG. 8.

At 1610, the method may include monitoring, based at least in part on receiving the control signaling, for a first one or more phase tracking reference signals according to a first pattern of the set of phase tracking reference signal patterns in a first portion of the transmission time interval. The operations of 1610 may be performed in accordance with examples as disclosed herein. In some examples, aspects of the operations of 1610 may be performed by a phase tracking component 830 as described with reference to FIG. 8.

At 1615, the method may include monitoring, based at least in part on receiving the control signaling, for a second one or more phase tracking reference signals according to a second pattern of the set of phase tracking reference signal patterns in a second portion of the transmission time interval. The operations of 1615 may be performed in accordance with examples as disclosed herein. In some examples, aspects of the operations of 1615 may be performed by a phase tracking component 830 as described with reference to FIG. 8.

At 1620, the method may include monitoring, in accordance with the control signaling, the transmission time interval for the downlink message based at least in part on a phase estimate determined using the first one or more phase tracking reference signals and the second one or more phase tracking reference signals. The operations of 1620 may be performed in accordance with examples as disclosed herein. In some examples, aspects of the operations of 1620 may be performed by a downlink signaling manager 835 as described with reference to FIG. 8.

At 1625, the method may include transmitting, based at least in part on monitoring for the first one or more phase tracking reference signals and the second one or more phase tracking reference signals, a signal indicating one or more phase tracking reference signal patterns of the set of phase tracking reference signal patterns. The operations of 1625 may be performed in accordance with examples as disclosed herein. In some examples, aspects of the operations of 1625 may be performed by a report manager 845 as described with reference to FIG. 8.

At 1630, the method may include monitoring, based at least in part on transmitting the signal, for a third one or more phase tracking reference signals according to a third pattern of the set of phase tracking reference signal patterns in a portion of a second transmission time interval. The operations of 1630 may be performed in accordance with examples as disclosed herein. In some examples, aspects of the operations of 1630 may be performed by a phase tracking component 830 as described with reference to FIG. 8.

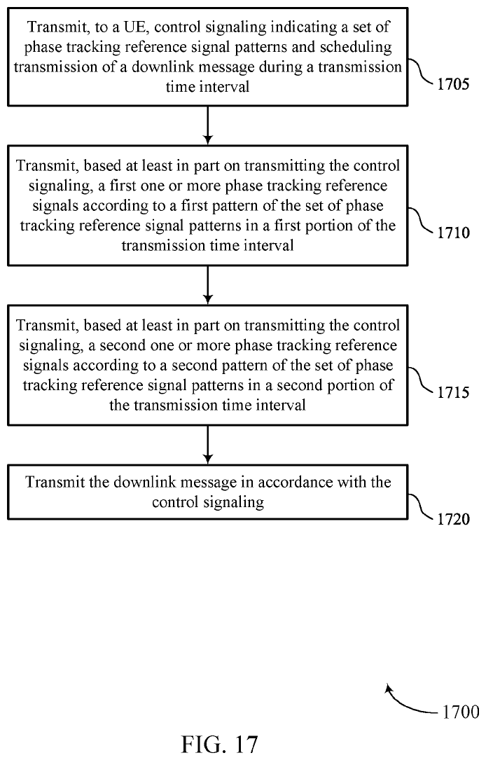

FIG. 17 shows a flowchart illustrating a method 1700 that supports techniques for configuring phase tracking reference signal transmissions in accordance with aspects of the present disclosure. The operations of the method 1700 may be implemented by a base station or its components as described herein. For example, the operations of the method 1700 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1705, the method may include transmitting, to a UE, control signaling indicating a set of phase tracking reference signal patterns and scheduling transmission of a downlink message during a transmission time interval. The operations of 1705 may be performed in accordance with examples as disclosed herein. In some examples, aspects of the operations of 1705 may be performed by a control signaling component 1225 as described with reference to FIG. 12.

At 1710, the method may include transmitting, based at least in part on transmitting the control signaling, a first one or more phase tracking reference signals according to a first pattern of the set of phase tracking reference signal patterns in a first portion of the transmission time interval. The operations of 1710 may be performed in accordance with examples as disclosed herein. In some examples, aspects of the operations of 1710 may be performed by a reference signal manager 1230 as described with reference to FIG. 12.

At 1715, the method may include transmitting, based at least in part on transmitting the control signaling, a second one or more phase tracking reference signals according to a second pattern of the set of phase tracking reference signal patterns in a second portion of the transmission time interval. The operations of 1715 may be performed in accordance with examples as disclosed herein. In some examples, aspects of the operations of 1715 may be performed by a reference signal manager 1230 as described with reference to FIG. 12.

At 1720, the method may include transmitting the downlink message in accordance with the control signaling. The operations of 1720 may be performed in accordance with examples as disclosed herein. In some examples, aspects of the operations of 1720 may be performed by a downlink transmission manager 1235 as described with reference to FIG. 12.

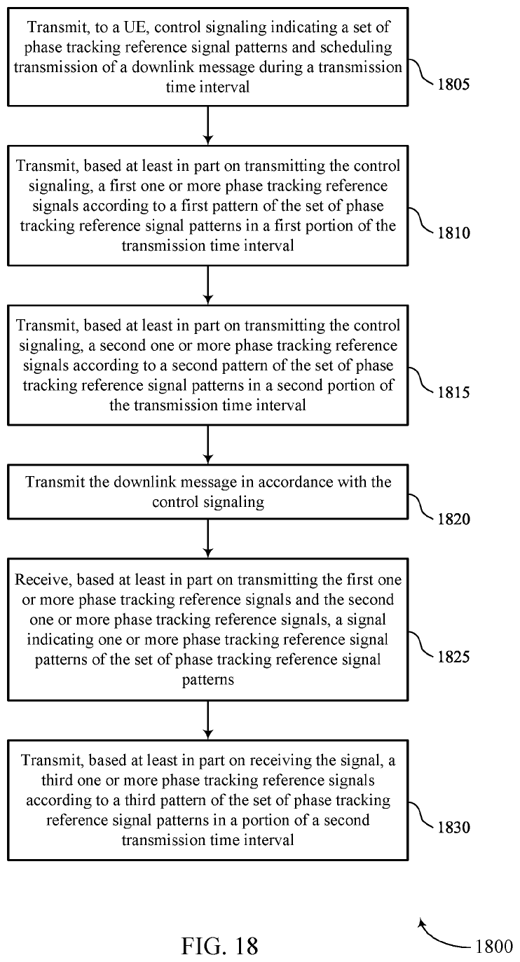

FIG. 18 shows a flowchart illustrating a method 1800 that supports techniques for configuring phase tracking reference signal transmissions in accordance with aspects of the present disclosure. The operations of the method 1800 may be implemented by a base station or its components as described herein. For example, the operations of the method 1800 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1805, the method may include transmitting, to a UE, control signaling indicating a set of phase tracking reference signal patterns and scheduling transmission of a downlink message during a transmission time interval. The operations of 1805 may be performed in accordance with examples as disclosed herein. In some examples, aspects of the operations of 1805 may be performed by a control signaling component 1225 as described with reference to FIG. 12.

At 1810, the method may include transmitting, based at least in part on transmitting the control signaling, a first one or more phase tracking reference signals according to a first pattern of the set of phase tracking reference signal patterns in a first portion of the transmission time interval. The operations of 1810 may be performed in accordance with examples as disclosed herein. In some examples, aspects of the operations of 1810 may be performed by a reference signal manager 1230 as described with reference to FIG. 12.

At 1815, the method may include transmitting, based at least in part on transmitting the control signaling, a second one or more phase tracking reference signals according to a second pattern of the set of phase tracking reference signal patterns in a second portion of the transmission time interval. The operations of 1815 may be performed in accordance with examples as disclosed herein. In some examples, aspects of the operations of 1815 may be performed by a reference signal manager 1230 as described with reference to FIG. 12.

At 1820, the method may include transmitting the downlink message in accordance with the control signaling. The operations of 1820 may be performed in accordance with examples as disclosed herein. In some examples, aspects of the operations of 1820 may be performed by a downlink transmission manager 1235 as described with reference to FIG. 12.

At 1825, the method may include receiving, based at least in part on transmitting the first one or more phase tracking reference signals and the second one or more phase tracking reference signals, a signal indicating one or more phase tracking reference signal patterns of the set of phase tracking reference signal patterns. The operations of 1825 may be performed in accordance with examples as disclosed herein. In some examples, aspects of the operations of 1825 may be performed by a report component 1245 as described with reference to FIG. 12.

At 1830, the method may include transmitting, based at least in part on receiving the signal, a third one or more phase tracking reference signals according to a third pattern of the set of phase tracking reference signal patterns in a portion of a second transmission time interval. The operations of 1830 may be performed in accordance with examples as disclosed herein. In some examples, aspects of the operations of 1830 may be performed by a reference signal manager 1230 as described with reference to FIG. 12.

The following provides an overview of aspects of the present disclosure:

Aspect 1: A method for wireless communication at a UE, comprising: receiving control signaling indicating a set of phase tracking reference signal patterns and scheduling transmission of a downlink message during a transmission time interval; monitoring, based at least in part on receiving the control signaling, for a first one or more phase tracking reference signals according to a first pattern of the set of phase tracking reference signal patterns in a first portion of the transmission time interval; monitoring, based at least in part on receiving the control signaling, for a second one or more phase tracking reference signals according to a second pattern of the set of phase tracking reference signal patterns in a second portion of the transmission time interval; and monitoring, in accordance with the control signaling, the transmission time interval for the downlink message based at least in part on a phase estimate determined using the first one or more phase tracking reference signals and the second one or more phase tracking reference signals.

Aspect 2: The method of aspect 1, further comprising: transmitting a signal indicating a UE capability associated with the set of phase tracking reference signal patterns, wherein the control signaling is received based at least in part on the UE capability.

Aspect 3: The method of aspect 2, wherein the signal is transmitted in a radio resource control message.

Aspect 4: The method of any of aspects 1 through 3, further comprising: transmitting, based at least in part on monitoring for the first one or more phase tracking reference signals and the second one or more phase tracking reference signals, a signal indicating one or more phase tracking reference signal patterns of the set of phase tracking reference signal patterns; and monitoring, based at least in part on transmitting the signal, for a third one or more phase tracking reference signals according to a third pattern of the set of phase tracking reference signal patterns in a portion of a second transmission time interval.

Aspect 5: The method of aspect 4, further comprising: receiving a lookup table identifying the set of phase tracking reference signal patterns, wherein the signal indicates the one or more phase tracking reference signal patterns based at least in part on the lookup table.

Aspect 6: The method of any of aspects 4 through 5, wherein the signal further indicates a quantity of symbols associated with the indicated one or more phase tracking reference signal patterns; and the portion of the second transmission time interval comprises the indicated quantity of symbols.

Aspect 7: The method of aspect 6, wherein the quantity of symbols are indicated in one or more bits in the signal.

Aspect 8: The method of any of aspects 4 through 7, wherein the indicated one or more phase tracking reference signal patterns comprise the third pattern.

Aspect 9: The method of any of aspects 4 through 8, wherein the indicated one or more phase tracking reference signal patterns are based at least in part on a channel delay spread, a back off associated with a fast Fourier transform operation, an integrated phase noise, or any combination thereof.

Aspect 10: The method of any of aspects 4 through 9, wherein the indicated one or more phase tracking reference signal patterns are based at least in part on a signal to interference plus noise ratio, a rank indicator, a channel quality indicator, a modulation and coding scheme, a precoding matrix indicator, or any combination thereof.

Aspect 11: The method of any of aspects 4 through 10, wherein the signal is transmitted in a periodic report or an aperiodic report.

Aspect 12: The method of any of aspects 4 through 11, wherein the signal is transmitted in a physical uplink channel transmission or in a channel state feedback report.

Aspect 13: The method of any of aspects 1 through 12, wherein the control signaling comprises a radio resource control message, a medium access control control element, a downlink control information message, or any combination thereof.

Aspect 14: A method for wireless communication at a base station, comprising: transmitting, to a UE, control signaling indicating a set of phase tracking reference signal patterns and scheduling transmission of a downlink message during a transmission time interval: transmitting, based at least in part on transmitting the control signaling, a first one or more phase tracking reference signals according to a first pattern of the set of phase tracking reference signal patterns in a first portion of the transmission time interval: transmitting, based at least in part on transmitting the control signaling, a second one or more phase tracking reference signals according to a second pattern of the set of phase tracking reference signal patterns in a second portion of the transmission time interval; and transmitting the downlink message in accordance with the control signaling.

Aspect 15: The method of aspect 14, further comprising: receiving a signal indicating a UE capability associated with the set of phase tracking reference signal patterns, wherein the control signaling is transmitted based at least in part on the UE capability.

Aspect 16: The method of aspect 15, wherein the signal is received in a radio resource control message.

Aspect 17: The method of any of aspects 14 through 16, further comprising: receiving, based at least in part on transmitting the first one or more phase tracking reference signals and the second one or more phase tracking reference signals, a signal indicating one or more phase tracking reference signal patterns of the set of phase tracking reference signal patterns; and transmitting, based at least in part on receiving the signal, a third one or more phase tracking reference signals according to a third pattern of the set of phase tracking reference signal patterns in a portion of a second transmission time interval.

Aspect 18: The method of aspect 17, further comprising: transmitting a lookup table identifying the set of phase tracking reference signal patterns, wherein the signal indicates the one or more phase tracking reference signal patterns based at least in part on the lookup table.

Aspect 19: The method of any of aspects 17 through 18, wherein the signal further indicates a quantity of symbols associated with the indicated one or more phase tracking reference signal patterns; and the portion of the second transmission time interval comprises the indicated quantity of symbols.

Aspect 20: The method of aspect 19, wherein the quantity of symbols are indicated in one or more bits in the signal.

Aspect 21: The method of any of aspects 17 through 20, wherein the indicated one or more phase tracking reference signal patterns comprise the third pattern.

Aspect 22: The method of any of aspects 17 through 21, wherein the indicated one or more phase tracking reference signal patterns are based at least in part on a channel delay spread, a back off associated with a fast Fourier transform operation, an integrated phase noise, or any combination thereof.

Aspect 23: The method of any of aspects 17 through 22, wherein the indicated one or more phase tracking reference signal patterns are based at least in part on a signal to interference plus noise ratio, a rank indicator, a channel quality indicator, a modulation and coding scheme, a precoding matrix indicator, or any combination thereof.

Aspect 24: The method of any of aspects 17 through 23, wherein the signal is received in a periodic report or an aperiodic report.

Aspect 25: The method of any of aspects 17 through 24, wherein the signal is received in a physical uplink channel transmission or in a channel state feedback report.

Aspect 26: The method of any of aspects 14 through 25, wherein the control signaling comprises a radio resource control message, a medium access control control element, a downlink control information message, or any combination thereof.

Aspect 27: An apparatus for wireless communication at a UE, comprising a processor; and a memory coupled with the processor, wherein the memory comprises instructions executable by the processor to cause the apparatus to perform a method of any of aspects 1 through 13.

Aspect 28: An apparatus for wireless communication at a UE, comprising at least one means for performing a method of any of aspects 1 through 13.

Aspect 29: A non-transitory computer-readable medium storing code for wireless communication at a UE, the code comprising instructions executable by a processor to perform a method of any of aspects 1 through 13.

Aspect 30: An apparatus for wireless communication at a base station, comprising a processor; and a memory coupled with the processor, wherein the memory comprises instructions executable by the processor to cause the apparatus to perform a method of any of aspects 14 through 26.

Aspect 31: An apparatus for wireless communication at a base station, comprising at least one means for performing a method of any of aspects 14 through 26.

Aspect 32: A non-transitory computer-readable medium storing code for wireless communication at a base station, the code comprising instructions executable by a processor to perform a method of any of aspects 14 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving control signaling indicating a set of phase tracking reference signal patterns and scheduling transmission of a downlink message during a transmission time interval;
monitoring, based at least in part on receiving the control signaling, for a first one or more phase tracking reference signals according to a first pattern of the set of phase tracking reference signal patterns in a first portion of the transmission time interval;
monitoring, based at least in part on receiving the control signaling, for a second one or more phase tracking reference signals according to a second pattern of the set of phase tracking reference signal patterns in a second portion of the transmission time interval; and
monitoring, in accordance with the control signaling, the transmission time interval for the downlink message based at least in part on a phase estimate determined using the first one or more phase tracking reference signals and the second one or more phase tracking reference signals.

2. The method of claim 1, further comprising:
transmitting a signal indicating a UE capability associated with the set of phase tracking reference signal patterns, wherein the control signaling is received based at least in part on the UE capability.

3. The method of claim 2, wherein the signal is transmitted in a radio resource control message.

4. The method of claim 1, further comprising:
transmitting, based at least in part on monitoring for the first one or more phase tracking reference signals and the second one or more phase tracking reference signals, a signal indicating one or more phase tracking reference signal patterns of the set of phase tracking reference signal patterns; and
monitoring, based at least in part on transmitting the signal, for a third one or more phase tracking reference signals according to a third pattern of the set of phase tracking reference signal patterns in a portion of a second transmission time interval.

5. The method of claim 4, further comprising:
receiving a lookup table identifying the set of phase tracking reference signal patterns, wherein the signal indicates the one or more phase tracking reference signal patterns based at least in part on the lookup table.

6. The method of claim 4, wherein:
the signal further indicates a quantity of symbols associated with the indicated one or more phase tracking reference signal patterns; and
the portion of the second transmission time interval comprises the indicated quantity of symbols.

7. The method of claim 6, wherein the quantity of symbols are indicated in one or more bits in the signal.

8. The method of claim 4, wherein the indicated one or more phase tracking reference signal patterns comprise the third pattern.

9. The method of claim 4, wherein the indicated one or more phase tracking reference signal patterns are based at least in part on a channel delay spread, a back off associated with a fast Fourier transform operation, an integrated phase noise, or any combination thereof.

10. The method of claim 4, wherein the indicated one or more phase tracking reference signal patterns are based at least in part on a signal to interference plus noise ratio, a rank indicator, a channel quality indicator, a modulation and coding scheme, a precoding matrix indicator, or any combination thereof.

11. The method of claim 4, wherein the signal is transmitted in a periodic report or an aperiodic report.

12. The method of claim 4, wherein the signal is transmitted in a physical uplink channel transmission or in a channel state feedback report.

13. The method of claim 1, wherein the control signaling comprises a radio resource control message, a medium access control control element, a downlink control information message, or any combination thereof.

14. A method for wireless communication at a base station, comprising:
transmitting, to a user equipment (UE), control signaling indicating a set of phase tracking reference signal patterns and scheduling transmission of a downlink message during a transmission time interval;
transmitting, based at least in part on transmitting the control signaling, a first one or more phase tracking reference signals according to a first pattern of the set of phase tracking reference signal patterns in a first portion of the transmission time interval;
transmitting, based at least in part on transmitting the control signaling, a second one or more phase tracking reference signals according to a second pattern of the set of phase tracking reference signal patterns in a second portion of the transmission time interval; and
transmitting the downlink message in accordance with the control signaling.

15. The method of claim 14, further comprising:
receiving a signal indicating a UE capability associated with the set of phase tracking reference signal patterns, wherein the control signaling is transmitted based at least in part on the UE capability.

16. The method of claim 15, wherein the signal is received in a radio resource control message.

17. The method of claim 14, further comprising:
receiving, based at least in part on transmitting the first one or more phase tracking reference signals and the second one or more phase tracking reference signals, a signal indicating one or more phase tracking reference signal patterns of the set of phase tracking reference signal patterns; and
transmitting, based at least in part on receiving the signal, a third one or more phase tracking reference signals according to a third pattern of the set of phase tracking reference signal patterns in a portion of a second transmission time interval.

18. The method of claim 17, further comprising:
transmitting a lookup table identifying the set of phase tracking reference signal patterns, wherein the signal indicates the one or more phase tracking reference signal patterns based at least in part on the lookup table.

19. The method of claim 17, wherein:
the signal further indicates a quantity of symbols associated with the indicated one or more phase tracking reference signal patterns; and
the portion of the second transmission time interval comprises the indicated quantity of symbols.

20. The method of claim 19, wherein the quantity of symbols are indicated in one or more bits in the signal.

21. The method of claim 17, wherein the indicated one or more phase tracking reference signal patterns comprise the third pattern.

22. The method of claim 17, wherein the indicated one or more phase tracking reference signal patterns are based at least in part on a channel delay spread, a back off associated with a fast Fourier transform operation, an integrated phase noise, or any combination thereof.

23. The method of claim 17, wherein the indicated one or more phase tracking reference signal patterns are based at least in part on a signal to interference plus noise ratio, a rank indicator, a channel quality indicator, a modulation and coding scheme, a precoding matrix indicator, or any combination thereof.

24. The method of claim 17, wherein the signal is received in a periodic report or an aperiodic report.

25. The method of claim 17, wherein the signal is received in a physical uplink channel transmission or in a channel state feedback report.

26. The method of claim 14, wherein the control signaling comprises a radio resource control message, a medium access control control element, a downlink control information message, or any combination thereof.

27. An apparatus for wireless communication at a user equipment (UE), comprising:
a processor; and
a memory coupled with the processor, wherein the memory comprises instructions executable by the processor to cause the apparatus to:
receive control signaling indicating a set of phase tracking reference signal patterns and scheduling transmission of a downlink message during a transmission time interval;
monitor, based at least in part on receiving the control signaling, for a first one or more phase tracking reference signals according to a first pattern of the set of phase tracking reference signal patterns in a first portion of the transmission time interval;
monitor, based at least in part on receiving the control signaling, for a second one or more phase tracking reference signals according to a second pattern of the set of phase tracking reference signal patterns in a second portion of the transmission time interval; and
monitor, in accordance with the control signaling, the transmission time interval for the downlink message based at least in part on a phase estimate determined using the first one or more phase tracking reference signals and the second one or more phase tracking reference signals.

28. The apparatus of claim 27, wherein the instructions are further executable by the processor to cause the apparatus to:
transmit a signal indicating a UE capability associated with the set of phase tracking reference signal patterns, wherein the control signaling is received based at least in part on the UE capability.

29. The apparatus of claim 27, wherein the instructions are further executable by the processor to cause the apparatus to:
transmit, based at least in part on monitoring for the first one or more phase tracking reference signals and the second one or more phase tracking reference signals, a signal indicating one or more phase tracking reference signal patterns of the set of phase tracking reference signal patterns; and
monitor, based at least in part on transmitting the signal, for a third one or more phase tracking reference signals according to a third pattern of the set of phase tracking reference signal patterns in a portion of a second transmission time interval.

30. An apparatus for wireless communication at a base station, comprising:
a processor; and
a memory coupled with the processor, wherein the memory comprises instructions executable by the processor to cause the apparatus to:
transmit, to a user equipment (UE), control signaling indicating a set of phase tracking reference signal patterns and scheduling transmission of a downlink message during a transmission time interval;
transmit, based at least in part on transmitting the control signaling, a first one or more phase tracking reference signals according to a first pattern of the set of phase tracking reference signal patterns in a first portion of the transmission time interval;
transmit, based at least in part on transmitting the control signaling, a second one or more phase tracking reference signals according to a second pattern of the set of phase tracking reference signal patterns in a second portion of the transmission time interval; and
transmit the downlink message in accordance with the control signaling.
